(19) United States
(12) Patent Application Publication
(10) Pub. No.: US 2013/0148330 A1
(43) Pub. Date: Jun. 13, 2013

(54) OPTICAL FILM, BACKLIGHT UNIT INCLUDING THE SAME, AND OPTICAL DISPLAY APPARATUS INCLUDING THE SAME

(71) Applicants: Hyoun Young KIM, Uiwang-si (KR); Sang Cheon PARK, Uiwang-si (KR); Jong Hyuk EUN, Uiwang-si (KR)

(72) Inventors: Hyoun Young KIM, Uiwang-si (KR); Sang Cheon PARK, Uiwang-si (KR); Jong Hyuk EUN, Uiwang-si (KR)

(21) Appl. No.: 13/710,607

(22) Filed: Dec. 11, 2012

(30) Foreign Application Priority Data
Dec. 12, 2011 (KR) 10-2011-0133085

(51) Int. Cl. G02B 1/04; B32B 3/26; G09F 13/04

(52) U.S. Cl. CPC G02B 1/04; G09F 13/04; B32B 3/263; G02B 1/041
USPC 362/97.1; 428/141; 524/521; 524/520; 524/523; 522/11

(57) ABSTRACT

An optical film, a backlight unit, and an optical display apparatus, the optical film including a base film, and an optical functional layer on at least one side of the base film, wherein at least one of the base film and the optical functional layer includes rubber.

### CROSS-REFERENCE TO RELATED APPLICATION

The present application claims priority under 35 U.S.C. §119 to Korean Patent Application No. 10-2011-0133085, filed on Dec. 12, 2011, in the Korean Intellectual Property Office, and entitled: “Optical Film Backlight Unit Including The Same And Optical Display Apparatus Including The Same,” which is incorporated by reference herein in its entirety.

### BACKGROUND

1. Field

Embodiments relate to an optical film, a backlight unit including the same, and an optical display apparatus including the same.

2. Description of the Related Art

In the structure of an optical film, a prism sheet may be used to help improve brightness of a liquid crystal display (LCD). Since the LCD cannot emit light by itself, it obtains light by means of a light source (e.g., CCFL or LED). The obtained light may be distributed through a light guide plate to an entire area, which is transformed to a surface light source having more uniform brightness through a diffusive sheet. In the course of this procedure, efficiency of light emitted from an initial light source may be steadily reduced. If a prism sheet is used, brightness may be increased by changing side light to front light and collecting the reflected light.

The prism sheet (used as a light collecting sheet) may be an optical film having thin film flexibility, which may form a surface structure such that a prism pattern is arranged in a linear array at one side, thereby improving brightness. In addition to brightness improvement through formation of physical structures, brightness improvement based on optical materials may also be considered. For this purpose, an index of refraction may be a main factor. For example, as the index of refraction increases, the properties of the prism film may be improved, thereby realizing high brightness.

### SUMMARY

Embodiments are directed to an optical film, a backlight unit including the same, and an optical display apparatus including the same.

Embodiments may be realized by providing an optical film including a base film, and an optical functional layer on at least one side of the base film, wherein at least one of the base film and the optical functional layer includes rubber.

The rubber may include at least one selected from the group of nitrile butadiene rubber, styrene butadiene rubber, silicone rubber, urethane rubber, (meth)acrylic rubber, chloroprene rubber, ethylene propylene diene monomer rubber, and fluorinated rubber.

The rubber may have a weight average molecular weight of about 1,000 g/mol to about 1,000,000 g/mol.

The rubber may be present in the optical film in an amount of about 1 wt % to about 50 wt %.

The optical functional layer may include a cured product of a composition, the composition including the rubber and a UV-curable unsaturated compound.

The UV-curable unsaturated compound may include at least one of a (meth)acrylate oligomer and a (meth)acrylate monomer.

The UV-curable unsaturated compound may include a (meth)acrylate oligomer or monomer containing about 10 mol % or more of an ethylene oxide group.

The (meth)acrylate oligomer or monomer containing about 10 mol % or more of an ethylene oxide group may be present in the composition in an amount of about 5 wt % to about 90 wt %.

The UV-curable unsaturated compound may be present in the composition in an amount of about 10 parts by weight to about 900 parts by weight, based on 100 parts by weight of the rubber.

The composition may further include at least one of an antistatic agent, a silicone additive, and an initiator.

The composition may include the antistatic agent, the antistatic agent including a resin obtained by combining an ion conductive polymer having ethylene oxide or propylene oxide to which ion conductive metals are ionically bound with a reactive silicone resin.

The composition may include the silicone additive, the silicone additive including at least one of a polyether siloxane copolymer and an organic modified polysiloxane compound.

The composition may include about 1 wt % to about 50 wt % of the rubber, about 25 wt % to about 90 wt % of the UV-curable unsaturated compound, about 0.1 wt % to about 10 wt % of the antistatic agent, about 0.01 wt % to about 10 wt % of the silicone additive, and about 0.5 wt % to about 7 wt % of the initiator.

The optical functional layer may include at least one optical pattern selected from among prisms, lenticular lenses, micro-lenses, and embossing shapes, the at least one optical pattern including the rubber.

The optical film may include a prism sheet, the prism sheet including the rubber.

Embodiments may also be realized by providing a backlight unit including the optical film according to an embodiment.

Embodiments may also be realized by providing an optical display apparatus including the optical film according to an embodiment.

### BRIEF DESCRIPTION OF THE DRAWINGS

Features will become apparent to those of skill in the art by describing in detail exemplary embodiments with reference to the attached drawings in which:

FIG. 1 illustrates a perspective view of an optical film according to an embodiment.

FIG. 2 illustrates a sectional view of a backlight unit according to an embodiment.

FIG. 3 illustrates a sectional view of an optical display apparatus according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

According to an embodiment, an optical film may include, e.g., a base film and an optical functional layer formed on the base film.

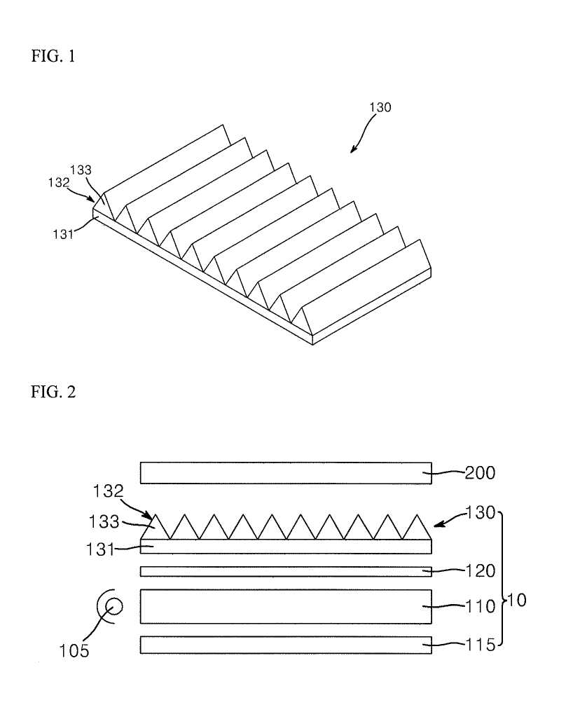

FIG. 1 illustrates a perspective view of an optical film according to an embodiment.

Referring to FIG. 1, the optical film 130 may include a base film 131 and an optical functional layer 132 formed on the base film 131. The optical functional layer 132 may comprise one or more optical patterns 133.

As used herein, the term “optical functional layer” may refer to a layer that functions to collect, diffuse, transmit, refract, or reflect light.

According to an embodiment, the optical film may include rubber. The rubber may be included in at least one of the base film and the optical functional layer. In an implementation, the rubber may be included in the optical functional layer.

The rubber may be included in the optical film and may be capable of improving self-recovery and scratch resistance, minimizing yellowing, and strengthening the improvement effect of antistatic properties of the optical film.

The rubber may have a weight average molecular weight of about 1,000 g/mol to about 1,000,000 g/mol. Within this range, the rubber may be compatible with other components included in the optical film, and may be readily available. In an implementation, the rubber may have a weight average molecular weight of about 10,000 g/mol to about 1,000,000 g/mol.

The rubber may be included as a liquid rubber polymer in a composition for the optical film, and may be subjected to or undergo a crosslinking reaction with a UV-curable unsaturated compound to be included in the optical film. For the crosslinking reaction, the liquid rubber polymer may include, e.g., an amino group, a hydroxyl group, a carboxylic acid group, an isocyanate group, a halogen group, an acrylic group, or the like, at ends of the polymer.

The rubber may include at least one selected from nitrile butadiene rubber (NBR), styrene butadiene rubber (SBR), silicone rubber, urethane rubber, (meth)acrylic rubber, chloroprene rubber (CR), ethylene propylene diene monomer (EPDM) rubber, and fluorinated rubber.

The rubber may be present in the optical film in an amount of about 1 wt % to about 50 wt %, e.g., about 10 wt % to about 40 wt % or about 30 wt % to about 40 wt %. Within this range, excellent self-recovery and scratch resistance of the optical film may be obtained.

The rubber may be present in the optical functional layer in an amount of about 1 wt % to about 50 wt %, e.g., about 10 wt % to about 40 wt % or about 30 wt % to about 40 wt %. Within this range, excellent self-recovery and scratch resistance of the optical film may be obtained.

The optical functional layer may perform functions of collecting, diffusing, transmitting, refracting, and/or reflecting light obtained from or passing through the base film. For example, the optical film may be used as a prism sheet, a diffusive sheet, a light guide plate, or the like.

The optical functional layer may have an optical pattern so as to perform the functions of collecting, diffusing, transmitting, refracting, and/or reflecting light. The optical pattern may include at least one of prisms, lenticular lenses, micro-lenses, embossed shapes, or the like. A height of the optical pattern may be about 30 μm to about 50 μm.

The optical functional layer may include a cured product of the composition including the liquid rubber polymer and the UV-curable unsaturated compound. The UV-curable unsaturated compound may form a matrix of the optical film by undergoing the crosslinking reaction with the liquid rubber polymer, e.g., the liquid polymer for forming the rubber. In an implementation, the UV-curable unsaturated compound may include at least one of (meth)acrylate oligomers and (meth)acrylate monomers.

As the (meth)acrylate oligomer, a suitable (meth)acrylate oligomer may be used. For example, a (meth)acrylate oligomer having a weight average molecular weight of about 1,000 g/mol to about 100,000 g/mol may be used. In an implementation, the (meth)acrylate oligomer may include at least one selected from urethane (meth)acrylates, epoxy(meth)acrylates, polyester(meth)acrylates, fluorine(meth)acrylates, fluorene(meth)acrylates, silicone(meth)acrylates, phosphate(meth)acrylates, maleimide modified (meth)acrylates, and acrylate(meth)acrylate.

The urethane(meth)acrylate may include an oligomer that is synthesized from a polyol, an isocyanate compound, and a (meth)acrylate and has a urethane bond in the molecular structure thereof. Examples of the polyol may include a polyester polyol, a polyether polyol, a polycarbonate polyol, a polycaprolactone polyol, a ring-opening tetrahydrofurane propylene oxide copolymer, polybutadiene diol, polydimethylsiloxane diol, ethylene glycol, propylene glycol, 1,4-butanediol, 1,5-pentanediol, 1,6-hexanediol, neopentyl glycol, 1,4-cyclohexane dimethanol, bisphenol-A, hydrogenated bisphenol-A, or mixtures. Examples of the isocyanate compound may include 2,4-toluene diisocyanate, 1,3-xylene diisocyanate, 1,4-xylene diisocyanate, 1,5-naphthalene diisocyanate, 1,6-hexane diisocyanate, isophorone diisocyanate, and mixtures thereof. Examples of the (meth)acrylate may include (meth)acrylates containing a C1 to C50 alkyl group and a hydroxyl group.

The epoxy(meth)acrylate may be selected from (meth)acrylate oligomers, the intermolecular structure of which includes a backbone of 2-bromohydroquinone, resorcinol, catechol, bisphenols such as bisphenol A, bisphenol F, bisphenol AD and bisphenol S, 4,4′-dihydroxybiphenyl, bis(4-hydroxyphenyl)ether, and the like; and (meth)acrylate oligomers, the intermolecular structure of which includes an alkyl, aryl, methylol, allyl, cycloaliphatic, halogen such as tetrabromobisphenol A, nitro group, and the like.

The maleimide modified (meth)acrylate may refer to an oligomer prepared from a compound having at least two maleimide groups and a (meth)acrylate. The compound may include at least one selected from the group of 1-methyl-2,4-bismaleimidebenzene, N,N′-m-phenylenebismaleimide, N,N-p-phenylenebismaleimide, N,N′-m-toluoylenebismaleimide, N,N′-4,4-biphenylenebismaleimide, N,N′-4,4-(3,3′-dimethylbiphenylene)bismaleimide, N,N′-4,4-(3,3′-dimethyldiphenylmethane)bismaleimide, N,N′-4,4-(3,3′-diethyldiphenylmethane)bismaleimide, N,N′-4,4-diphenylmethane bismaleimide, N,N′-4,4-diphenylpropanebismaleimide, N,N′-4,4-diphenyletherbismaleimide, 2,2-bis(4-(4-maleimidephenoxy)phenyl)propane, 2,2-bis(3-t-butyl-4-(4-maleimidephenoxy)phenyl)propane, 1,1-bis(4-(4-maleimidephenoxy)phenyl)decane, 4,4′-cyclohexylidene bis(1-(4-maleimidephenoxy)-2-cyclohexylbenzene, 2,2-bis(4-(4-maleimidephenoxy)phenyl)hexafluoropropane, and mixtures thereof. The (meth)acrylate may be a (meth)acrylate having C1 to C50 alkyl group.

In an implementation, the (meth)acrylate oligomer may include at least one selected from fluorene (meth)acrylates, bisphenol A epoxy(meth)acrylates, bisphenol F epoxy(meth)acrylates, and novolac epoxy(meth)acrylates.

According to an embodiment, a suitable (meth)acrylate monomer may be used. For example, the (meth)acrylate monomer may include at least one selected from benzyl(meth)acrylate, phenoxybenzyl(meth)acrylate, 2-phenylphenoxyethyl(meth)acrylate, 1,6-hexanediol mono(meth)acrylate, 2-hydroxyethyl(meth)acrylate, 2-hydroxypropyl(meth)acrylate, 2-hydroxybutyl(meth)acrylate, 2-hydroxy-3-phenyloxypropyl(meth)acrylate, 1,4-butanediol mono or di(meth)acrylate, 2-hydroxyethyl(meth)acryloyl phosphate, 4-hydroxycyclohexyl(meth)acrylate, neopentylglycol mono(meth)acrylate, trimethylolethane di(meth)acrylate, trimethylolpropane di(meth)acrylate, pentaerythritol tri(meth)acrylate, dipentaerythritol penta(meth)acrylate, dipentaerythritol hexa(meth)acrylate, glycerin di(meth)acrylate, tetra-hydrofurfuryl(meth)acrylate, iso-decyl(meth)acrylate, 2-(2-ethoxyethoxy)ethyl(meth)acrylate, stearyl(meth)acrylate, lauryl(meth)acrylate, 2-phenoxyethyl(meth)acrylate, isobornyl(meth)acrylate, tridecyl(meth)acrylate, ethoxy addition type nonylphenol(meth)acrylate, ethylene glycol di(meth)acrylate, diethylene glycol di(meth)acrylate, triethylene glycol di(meth)acrylate, tetra-ethylene glycol di(meth)acrylate, polyethylene glycol di(meth)acrylate, 1,3-butylene glycol di(meth)acrylate, tripropylene glycol di(meth)acrylate, ethoxy addition type bisphenol-A di(meth)acrylate, cyclohexane dimethanol di(meth)acrylate, phenoxy-tetra-glycol(meth)acrylate, 2-(meth)acryloyloxyethyl phosphate, dimethylol tricyclodecane di(meth)acrylate, trimethylolpropane benzoate acrylate, fluorene(meth)acrylate, bisphenol F (meth)acrylate, bisphenol A epoxy(meth)acrylate, novolac epoxy(meth)acrylate, phenylphenoxyethyl(meth)acrylate, ethoxylated thiodiphenyl di(meth)acrylate, and phenylthioethyl(meth)acrylate.

In an implementation, the UV-curable unsaturated compound may include a (meth)acrylate oligomer or monomer containing 10 mol % or more of an ethylene oxide group. The (meth)acrylate containing about 10 mol % or more of an ethylene oxide group may help improve elasticity and self-recovery of the optical film, thereby improving scratch resistance of the optical film. The (meth)acrylate oligomer or monomer thereof may include about 10 mol % to about 50 mol % of the ethylene oxide group, e.g., about 10 mol % to about 40 mol % or about 10 mol % to about 30 mol %.

As used herein, the term “ethylene oxide group” may refer to —CH₂—CH₂—O— or —O—CH₂—CH₂—.

The (meth)acrylate oligomer or monomer containing about 10 mol % or more of the ethylene oxide group may be present in the optical film in an amount of about 5 wt % to about 90 wt %. Within this range, elasticity of the optical film may be enhanced, thereby improving self-recovery properties and scratch resistance of the optical film. In an implementation, the (meth)acrylate oligomer or monomer containing 10 mol % or more of the ethylene oxide group may be present in the optical film in an amount of about 5 wt % to about 80 wt %, e.g., about 10 wt % to about 70 wt % or about 10 wt % to about 50 wt %.

The cured product of the UV-curable unsaturated compound may be present in an amount of about 10 parts by weight to about 900 parts by weight, based on 100 parts by weight of the rubber. Within this range, wettability to the base film may be good, and thus degradation of adhesion may be reduced and/or prevented. Further, flexibility of the polymer main chain may be not decreased. Thus, cracking may be less likely to occur after manufacture of the optical film, especially, a prism film. The cured product of the UV-curable unsaturated compound may be present in an amount of about 50 parts by weight to about 300 parts by weight, e.g., about 100 parts by weight to about 250 parts by weight or about 135 parts by weight to about 213 parts by weight.

The cured product of the UV-curable unsaturated compound may be present in the optical film in an amount of about 25 wt % to about 90 wt %. Within this range, the matrix may have a stable cross-linked network. The cured product of the UV-curable unsaturated compound may be present in the optical film in an amount of about 50 wt % to about 80 wt %, e.g., about 54 wt % to about 64 wt %.

The optical film may have a yellow index (ΔYI) of about 6.0 or less, e.g., about 5.1 to 5.9, measured after the optical film has been left at 50° C. under 0.34 W/m² for 200 hours.

The optical film may be manufactured from a composition including the liquid rubber and the UV-curable unsaturated compound. The liquid rubber may refer to the liquid polymer for forming the rubber, e.g., the liquid polymer rubber. Detailed description thereof is as mentioned above.

The liquid rubber may be present in the composition in an amount of about 1 wt % to about 50 wt %, e.g., about 10 wt % to about 40 wt % or about 30 wt % to about 40 wt %. Within this range, self-recovery properties and excellent scratch resistance of the optical film may be obtained.

A detailed description of the UV-curable unsaturated compound is given above.

The UV-curable unsaturated compound may be present in the composition in an amount of about 25 wt % to about 90 wt %. Within this range, the matrix of the optical film may have a stable cross-linked network. In an implementation, the UV-curable unsaturated compound may be present in an amount of about 50 wt % to about 80 wt %, e.g., about 54 wt % to about 64 wt %.

The composition may further include, e.g., an initiator, an antistatic agent, and/or a silicone additive, in addition to the liquid rubber and UV-curable unsaturated compound.

The antistatic agent may help reduce and/or prevent accumulation of static charge in production or assembly of the optical film produced after curing the composition. A suitable antistatic agent may be used. For example, the antistatic agent may be prepared by combining a reactive silicone resin with an ion conductive polymer having ethylene oxide or propylene oxide ionically bonded to an ion conductive metal.

The antistatic agent may be a resin in which an ion conductive polymer is bound to a reactive silicone chain. For example, the antistatic agent may be represented by Formula I, below.

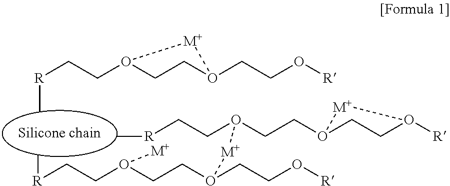

In Formula I, R may be —(CH₂)ₘ— or —O—; m may be an integer ranging from 1 to 10; R′ may be —CH₃, —CH═CH₂ or —C(CH₃)═CH₂; and M may be an alkali metal. In an implementation, M may be lithium.

The antistatic agent may be prepared by combining an ion conductive polymer having ethylene oxide or propylene oxide to which ion conductive metals are ionically bound with a reactive silicone resin, or may be commercially available. For example, the antistatic agent may include at least one selected from the group of HR-E, ELECON-600DA and ELECON-700DA (all available from NANO COMETECH Co., Ltd.), Ionic Liquid Series, such as IL-A21-9, IL-A2 and IL-A5 (all available from KOEI Co., Ltd.), and the like.

The antistatic agent may be present in the composition in an amount of about 0.1 wt % to about 10 wt %, e.g., about 0.1 wt % to about 5 wt %. Within this range, antistatic effects may be demonstrated, and ionic components may not bleed from the optical film in a significant amount under high temperature/high humidity conditions, thereby reducing and/or preventing degradation in adhesion between interfaces and mechanical and optical properties of the optical film.

The silicone additive may help improve mold release properties upon releasing the composition from a mold. As the silicone additive, polyether siloxane copolymers, organic modified polysiloxane compounds or mixtures thereof may be used. Examples of commercially available silicone additives may include BYK UV-3500, BYK UV-3530 (available from BYK Co., Ltd.), or TEGO Glide-100, TEGO Glide-ZG400, TEGO Glide-450 (all available from TEGO Co., Ltd.), and the like.

The silicone additive may be present the composition in an amount of about 0.01 wt % to about 10 wt %, e.g., about 0.01 wt % to about 5 wt % in. Within this range, mold release properties may be increased without a deterioration in adhesion between interfaces under high temperature/high humidity conditions and mechanical and optical properties of the optical film.

The initiator may be used to cure the composition by UV radiation. The initiator may include at least one selected from the group of photopolymerization initiators and radical initiators. Examples of the initiator may include propanone, ketone, phosphine oxide, and phosphate initiators.

The initiator may be present in the composition in an amount of about 0.5 wt % to about 7 wt %, e.g., about 1 wt % to about 6 wt %. Within this range, high photoreactivity may be obtained without a deterioration in mechanical strength of the optical film and a deterioration of optical properties (such as yellowing of a prism layer).

The composition may have a viscosity of about 300 cps to about 3,000 cps at 25° C. and 10˜100 rpm. Such a viscosity may be suitable for production of the optical film.

The optical film may be produced by a suitable method using the composition for optical films. The composition for optical film may be used for preparing the optical functional layer or the base film of the optical film.

In an implementation, the method of producing an optical film may include: coating a composition for an optical film on a mold engraving roll having a prism layer engraved thereon; curing the composition coated on the engraving roll while contacting one side of a base film; and releasing a coating layer of the composition, which is cured and attached to the base film, from the engraving roll to obtain the optical film.

Coating of the composition for the optical film on the mold engraving roll having a prism layer engraved thereon may be performed by a suitable coating method.

As the base film, a transparent material, e.g., glass, transparent synthetic resins, or the like may be used. In an implementation, a polyethylene terephthalate resin may be used.

In an implementation, the method of producing an optical film may include: (a) coating a composition for an optical film on a release film to form a first coating layer; (b) coating a resin composition for an optical functional layer on a mold engraving roll to form a second coating layer; (c) bringing the second coating layer into contact with one side of the first coating layer; (d) irradiating the first or second coating layer with UV light to cure the first and second coating layers; and (e) releasing the cured first and second coating layers from the mold engraving roll.

The resin composition for the optical functional layer may include a UV-curable unsaturated compound and an initiator. A suitable resin composition that is used for production of existing films capable of collecting, diffusing, transmitting, refracting, and/or reflecting light may be used to form the optical functional layer.

Curing of the composition for the optical film may be performed by, e.g., irradiating UV at a wavelength of about 190 nm to about 450 nm and an intensity of about 100 mJ/cm² to about 900 mJ/cm².

Another embodiment provides a backlight unit including the optical film. For example, the optical film may include a prism film.

FIG. 2 illustrates a sectional view of a backlight unit according to an embodiment.

Referring to FIG. 2, the backlight unit 10 may include a light source 105, a light guide plate 110, a reflection plate 115, a diffusion sheet 120 and an optical film 130.

The light source 105 may be disposed at one of a side surface or a rear surface of the light guide plate 110. The light source 105 may be cold cathode fluorescence lamp(CCFL), or LED(light emitting diode).

The light guide plate 110 may be disposed below and LCD panel 200 and near a side of the light source 105.

The reflection plate 115 may be disposed below the light guide plate 110.

The diffusion sheet 120 may be disposed above the light guide plate 110.

The optical film 130 may be disposed above the diffusion plate 120. The optical film 130 may be used as a prism sheet. The optical film 130 may include a base film 131 and an optical functional layer 132 formed on the base film 131. The optical functional layer 132 may comprise one or more optical patterns 133.

Another embodiment provides an optical display apparatus including the optical film or the backlight unit. For example, the optical display apparatus may include a liquid crystal display.

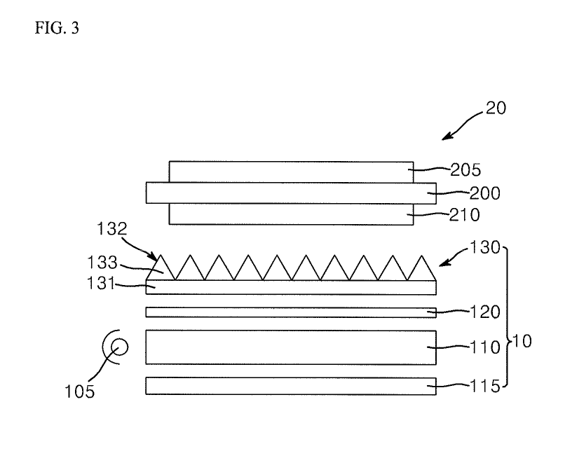

FIG. 3 illustrates a sectional view of an optical display apparatus according to an embodiment.

Referring the FIG. 3, the apparatus 20 may include the LCD panel 200 and the backlight unit 10.

The backlight unit 10 may be disposed at rear side of the LCD panel 200.

The apparatus 20 may include polarizers 205 and 210 formed at both sides of the LCD panel 200.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

Details of components used in examples and comparative examples are as follows:

Liquid Rubber:

(A1) Urethane liquid rubber (PU340, MIWON Commercial Co., Ltd.)

(A2) Urethane liquid rubber (HSC2067, HS Chemtron Co., Ltd.)

(A3) Urethane liquid rubber (HSC3007, HS Chemtron Co., Ltd.)

(A4) NBR liquid rubber (N280, Kenima Co., Ltd.)

(A5) Silicone liquid rubber (UV Electro 235-2, Momentive Co., Ltd.)

(A6) Silicone liquid rubber (UV LSR 2060, Momentive Co., Ltd.)

UV-curable unsaturated compound: (B1) Phenoxybenzyl acrylate, (B2) Acrylate containing 10 mol % of ethylene oxide, (B3) Acrylate containing 30 mol % of ethylene oxide, (B4) Fluorene acrylate, (B5) Bisphenol F acrylate, (B6) Novolac epoxy acrylate, (B7) Phenylphenoxy ethyl acrylate, (B8) Bisphenol A epoxy acrylate, (B9) Ethoxylated thiodiphenyl diacrylate

Antistatic agent: Silicone modified ion conductive acrylate (HR-E, NANO Chemtech Co., Ltd.)

Silicone additive: Polydimethylsiloxane containing polyether modified acrylic functional group (UV-3530, BYK Co., Ltd.)

Initiator: (E1) 1-hydroxy-cyclohexyl-phenyl-ketone (Irgacure 184, Ciba Specialty Chemicals and (E2) 2,4,6-trimethylbenzoyl diphenyl phosphine oxide (Chemcure TPO)

High hardness urethane acrylate: Miramer PU370 (MIWON commercial Co., Ltd.)

### Example 1

### Production of Optical Film

A composition for an optical film was prepared by mixing the components in amounts (unit: parts by weight) as listed in Table 1, below. A prism film having a prism layer formed on one side of a base film was produced by coating the composition on a soft mold or metal mold (which had a prism layer engraved thereon), irradiating UV on one side of the base film contacting the coating layer on the engraved mold to photocure the composition, and releasing the cured coating layer adhered to the base film from the engraved mold. The prism layer included rubber. The prism layer was formed to a height of 30 μm and UV was irradiated at an intensity of 500 mJ/cm² and a wavelength of 190 nm from an electrodeless UV irradiator (600 W/inch) equipped with a D-type bulb.

### Examples 2-6 and Comparative Examples 1-2

The compositions and the optical films were produced in the same manner as in Example 1 except for the amounts of the components as listed in Table 1. Results are shown in Table 1.

TABLE 1

| | | | | | | | | Comparative | |
|---|---|---|---|---|---|---|---|---|---|
| | | Examples | | | | | | Examples | |
| | | 1 | 2 | 3 | 4 | 5 | 6 | 1 | 2 |
| (A) | (A1) | 40 | — | — | — | — | — | — | — |
| | (A2) | — | 40 | — | — | — | — | — | — |
| | (A3) | — | — | 40 | — | — | — | — | — |
| | (A4) | — | — | — | 30 | — | — | — | — |
| | (A5) | — | — | — | — | 30 | 15 | — | — |
| | (A6) | — | — | — | — | — | 20 | — | — |
| (B) | (B1) | 20 | 20 | 25 | 20 | 20 | 15 | 20 | 20 |
| | (B2) | — | 10 | — | — | — | 10 | — | — |
| | (B3) | 10 | — | — | — | — | — | 50 | — |
| | (B4) | — | — | 15 | — | 14 | — | — | — |
| | (B5) | — | 10 | — | 20 | — | — | — | 20 |
| | (B6) | 24 | — | — | — | 15 | — | 24 | — |
| | (B7) | — | — | 14 | — | 15 | — | — | — |
| | (B8) | — | 14 | — | — | — | 20 | — | — |
| | (B9) | — | — | — | 24 | — | 14 | — | 24 |
| (C) | | 2 | 2 | 2 | 2 | 2 | 2 | 2 | 2 |
| (D) | | 1 | 1 | 1 | 1 | 1 | 1 | 1 | 1 |
| (E) | (E1) | 2 | 2 | 2 | 2 | 2 | 2 | 2 | 2 |
| | (E2) | 1 | 1 | 1 | 1 | 1 | 1 | 1 | 1 |
| (F) | | — | — | — | — | — | — | — | 30 |

The prepared optical films or compositions were tested as to physical properties. Results are summarized in Table 2, below.

1) Index of refraction: A refractometer (Model: 1T, ATAGO ABBE, Japan) was used to measure the index of refraction of the composition. A D-type sodium lamp of 589.3 nm was used as a light source.

2) Brightness (Cd/m²): The prism film was fixed to a backlight unit for 17 inch liquid crystal display panels. Then, brightness was measured at 25 points and 9 points on the liquid crystal display panel using a spectrophotometer (Model: BM-7, TOPCON Company, Japan) and the measured values were averaged.

3) Scratch resistance (g): After coating and curing a composition on a transparent PET base film, the cured prism layer was turned over so as to contact an antiglare side, on which a weight of about 500 g was placed. The weight was reciprocated a distance of 10 cm 10 times and the mass when the prism layer started to be scratched was measured.

4) Yellow Index (ΔYI): The optical film was left in a weather-O-meter at 50° C. and 0.34W/m² for 200 hours and color change was measured using a colorimeter.

5) Adhesive force (Number of residual matrix): After coating and curing a photocurable resin composition on a transparent PET base film, the cured prism layer was cut into 100 matrix cells each having an area of 10×10 mm². A tape was attached to the cells and the number of cells released from the tape was measured when vertically releasing the prism layer.

6) Surface resistance (Ω/cm²): After coating and curing a photocurable resin composition on a transparent PET base film, a constant voltage was applied using a DSM-8103 (Toadenshi Kogyo Co., Ltd., Japan) to measure the surface resistance.

7) Mold release properties: The photocurable resin compositions were introduced between a polyester base film and a metal mold having a prism shape engraved thereon. After lamination, the mold release properties upon releasing the base film from the metal mold was evaluated as 0˜10 points. 10-point is defined as excellent mold release properties.

8) Viscosity: The viscosity of the composition was measured using a Brookfield viscometer (DV-II+ PRO viscometer, Brookfield Co.) at 25° C. and 10˜100 rpm.

TABLE 2

| | | | | Yellow | Adhesive | Surface | Mold | |
|---|---|---|---|---|---|---|---|---|
| | Index of | Brightness | Scratch | Index | strength | resistance | Releasing | Viscosity |
| | refraction | (Cd/m²) | resistance (g) | (ΔYI) | (Number) | (Ω/cm²) | Property | (cps) |
| Example 1 | 1.540 | 3475 | 610 | 5.4 | 100 | 4.0 × 10¹¹ | 10 | 950 |
| Example 2 | 1.548 | 3525 | 590 | 5.5 | 100 | 3.2 × 10¹⁰ | 10 | 1,000 |
| Example 3 | 1.550 | 3531 | 550 | 5.1 | 100 | 3.9 × 10¹⁰ | 10 | 890 |
| Example 4 | 1.551 | 3539 | 530 | 5.1 | 100 | 3.0 × 10¹¹ | 10 | 860 |
| Example 5 | 1.549 | 3530 | 570 | 5.9 | 100 | 2.5 × 10¹⁰ | 10 | 1,520 |
| Example 6 | 1.556 | 3567 | 650 | 5.3 | 100 | 2.7 × 10¹¹ | 10 | 1,300 |
| Comparative | 1.541 | 3471 | 180 | 7.7 | 90 | 9.1 × 10¹² | 8 | 280 |
| Example 1 | | | | | | | | |
| Comparative | 1.532 | 3424 | 90 | 7.3 | 95 | 4.3 × 10¹² | 8 | 250 |
| Example 2 | | | | | | | | |

As shown in Table 2, it may be seen that the optical films according to the embodiments exhibited excellent scratch resistance, and improved brightness, index of refraction, and adhesive strength to the base film. Further, it may also be seen that the compositions for optical films according to the embodiments had viscosity suited to processing and excellent mold release properties, and excellent antistatic effect since it included an antistatic agent and the like.

By way of summation and review, in order to improve brightness, it may be important for the prism sheet to have desired optical properties (such as indexes of refraction of the prism film and photo-curable materials) for prisms. However, shrinkage of films and coating agents, and shape deformation due to external impact caused by accidents (in the course of transportation after formation of the prism sheet, in the course of backlight unit operation, or the like) may be encountered in the prism sheet. Thus, a prism sheet based on a photocurable composition having self-recovery properties using urethane acrylates having a low index of refraction and more or less elasticity may be used. However, due to limitation in terms of self-recovery, such a prism sheet may not improve brightness.

The embodiments provide an optical film having excellent brightness, scratch resistance, antistatic properties, and low yellowing, and being capable of minimizing a defect rate upon assembling a backlight unit.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An optical film, comprising:
a base film, and
an optical functional layer on at least one side of the base film,
wherein at least one of the base film and the optical functional layer includes rubber.

2. The optical film as claimed in claim 1, wherein the rubber includes at least one selected from the group of nitrile butadiene rubber, styrene butadiene rubber, silicone rubber, urethane rubber, (meth)acrylic rubber, chloroprene rubber, ethylene propylene diene monomer rubber, and fluorinated rubber.

3. The optical film as claimed in claim 1, wherein the rubber has a weight average molecular weight of about 1,000 g/mol to about 1,000,000 g/mol.

4. The optical film as claimed in claim 1, wherein the rubber is present in the optical film in an amount of about 1 wt % to about 50 wt %.

5. The optical film as claimed in claim 1, wherein the optical functional layer includes a cured product of a composition, the composition including the rubber and a UV-curable unsaturated compound.

6. The optical film as claimed in claim 5, wherein the UV-curable unsaturated compound includes at least one of a (meth)acrylate oligomer and a (meth)acrylate monomer.

7. The optical film as claimed in claim 5, wherein the UV-curable unsaturated compound includes a (meth)acrylate oligomer or monomer containing about 10 mol % or more of an ethylene oxide group.

8. The optical film as claimed in claim 7, wherein the (meth)acrylate oligomer or monomer containing about 10 mol % or more of an ethylene oxide group is present in the composition in an amount of about 5 wt % to about 90 wt %.

9. The optical film as claimed in claim 5, wherein the UV-curable unsaturated compound is present in the composition in an amount of about 10 parts by weight to about 900 parts by weight, based on 100 parts by weight of the rubber.

10. The optical film as claimed in claim 5, wherein the composition further includes at least one of an antistatic agent, a silicone additive, and an initiator.

11. The optical film as claimed in claim 10, wherein the composition includes the antistatic agent, the antistatic agent including a resin obtained by combining an ion conductive polymer having ethylene oxide or propylene oxide to which ion conductive metals are ionically bound with a reactive silicone resin.

12. The optical film as claimed in claim 10, wherein the composition includes the silicone additive, the silicone additive including at least one of a polyether siloxane copolymer and an organic modified polysiloxane compound.

13. The optical film as claimed in claim 10, wherein the composition includes:
about 1 wt % to about 50 wt % of the rubber,
about 25 wt % to about 90 wt % of the UV-curable unsaturated compound,
about 0.1 wt % to about 10 wt % of the antistatic agent,
about 0.01 wt % to about 10 wt % of the silicone additive, and
about 0.5 wt % to about 7 wt % of the initiator.

14. The optical film as claimed in claim 1, wherein the optical functional layer includes at least one optical pattern selected from among prisms, lenticular lenses, micro-lenses, and embossing shapes, the at least one optical pattern including the rubber.

15. The optical film as claimed in claim 1, wherein the optical film includes a prism sheet, the prism sheet including the rubber.

16. A backlight unit comprising the optical film as claimed in claim 1.

17. An optical display apparatus comprising the optical film as claimed in claim 1.
